(19) United States
(12) Patent Application Publication
(10) Pub. No.: US 2026/0287435 A1
(43) Pub. Date: Sep. 24, 2026

(54) BOLOMETER ARRAY

(71) Applicant: NEC Corporation, Tokyo (JP)

(72) Inventors: Akinobu SHIBUYA, Tokyo (JP); Tomo Tanaka, Tokyo (JP); Ryota Yuge, Tokyo (JP); Masahiko Sano, Tokyo (JP)

(73) Assignee: NEC Corporation, Tokyo (JP)

(21) Appl. No.: 19/564,317

(22) Filed: Mar. 12, 2026

(30) Foreign Application Priority Data
Mar. 24, 2025 (JP) 2025-048469

(51) Int. Cl. G01J 5/20; G01J 5/08

(52) U.S. Cl. CPC G01J 5/20; G01J 5/0814; G01J 2005/202

(57) ABSTRACT

A bolometer array includes: a first bolometer element including a first absorption film and capable of absorbing infrared rays falling within a first wavelength band; and a second bolometer element including a second absorption film and capable of absorbing infrared rays falling within a second wavelength band included in the first wavelength band described above.

This application is based upon and claims the benefit of priority from Japanese patent application No. 2025-048469, filed on March 24, 2025, the disclosure of which is incorporated herein in its entirety by reference.

### TECHNICAL FIELD

The present disclosure relates to a bolometer array.

### BACKGROUND ART

It is known that a bolometer is used to detect infrared rays.

For a purpose of detecting infrared rays falling within a plurality of wavelength bands, JP 2013-530386 A, for example, discloses a plurality of Infrared (IR) detector elements each including a filter that limits absorbed radiation light within a certain spectral band pass range.

### SUMMARY

When a filter that limits a wavelength of radiation light to be absorbed is provided, a structure of each IR detector element becomes complicated. In this case, it may be difficult to manufacture a bolometer array.

An object of the present disclosure is to provide a bolometer array that is capable of detecting infrared rays falling within a plurality of wavelength bands and is easy to manufacture.

A bolometer array according to an aspect of the present disclosure includes: a first bolometer element including a first absorption film and capable of absorbing infrared rays falling within a first wavelength band; and a second bolometer element including a second absorption film and capable of absorbing infrared rays falling within a second wavelength band included in the first wavelength band described above.

According to the aspect described above, it is easy to manufacture a bolometer array capable of detecting infrared rays falling within a plurality of wavelength bands.

### BRIEF DESCRIPTION OF THE DRAWINGS

FIG. 1 is a perspective view of a bolometer array according to an example embodiment;

FIG. 2 is a plan view illustrating an example of the bolometer array according to the example embodiment;

FIG. 3 is a plan view illustrating another example of the bolometer array according to the example embodiment;

FIG. 4 is a cross-sectional view of a first bolometer element according to the example embodiment;

FIG. 5 is another example of the cross-sectional view of the first bolometer element according to the example embodiment;

FIG. 6 is a cross-sectional view of a second bolometer element according to the example embodiment;

FIG. 7 is another example of the cross-sectional view of the second bolometer element according to the example embodiment;

FIG. 8 is a perspective view of a bolometer array according to an example embodiment;

FIG. 9 is a view illustrating an absorption spectrum of a first absorption film according to an example;

FIG. 10 is a view illustrating an absorption spectrum of a first absorption film according to an example;

FIG. 11 is a view illustrating an absorption spectrum of a first absorption film according to an example;

FIG. 12 is a view illustrating an absorption spectrum of a second absorption film according to an example;

FIG. 13 is a view illustrating an absorption spectrum of a second absorption film according to an example;

FIG. 14 is a view illustrating an absorption spectrum of a second absorption film according to an example; and

FIG. 15 is a view illustrating an absorption spectrum of a second absorption film according to an example.

### EXAMPLE EMBODIMENT

Hereinafter, example embodiments according to the present disclosure will be described with reference to the drawings. The drawings and specific configurations used in the example embodiments should not be used for interpretation of the disclosure. In all the drawings, the same or related components are denoted by the same reference numerals, and the common description will be omitted.

In the present disclosure, the drawings are associated with one or more example embodiments.

### First Example Embodiment

Hereinafter, one example embodiment according to the present disclosure will be described with reference to the drawings.

### Bolometer Array

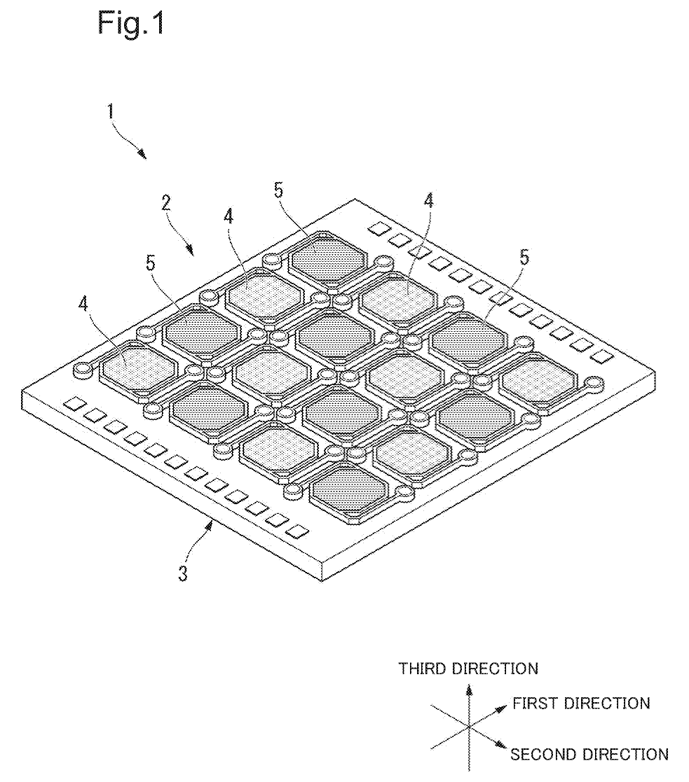

As illustrated in FIG. 1, a bolometer array 1 includes a plurality of bolometer elements 2 and a substrate 3.

The bolometer array 1 is a device for detecting infrared rays. The bolometer array 1 is applied to, for example, an uncooled infrared camera.

Each of the bolometer elements 2 is an element (an IR detection element described above) serving as a pixel in the bolometer array 1.

### Configuration of Substrate

Although the substrate 3 is preferably an Si substrate processed by using a silicon wafer, there is no limitation. An insulating film such as an oxide film may be formed on a surface of the Si substrate.

For example, a readout circuit may be formed on the substrate 3.

For example, a structure called micro electro mechanical systems (MEMS) in which a lower portion of the bolometer is hollowed may be formed on the substrate 3 to sufficiently secure an amount of rise in temperature along with absorption of infrared rays.

For example, a polymer film such as Parylene (registered trademark) having a low thermal conductivity may be formed on the substrate 3 to ensure thermal insulating properties.

For example, the substrate 3 may have an underlying insulating layer for electrical insulation. As a method for forming the underlying insulating layer, existing methods include a method for allowing the substrate 3 to undergo heat treatment, a method for directly forming an underlying insulating layer with a chemical vapor deposition (CVD) method, a method for applying a solution in which a polymer or a polymer precursor is dissolved through spin coating and heat treatment to form a polymer film, and the like. Examples of the underlying insulating layer include silicon oxide, silicon nitride, polyimide, and Parylene (registered trademark).

The substrate 3 is provided with the plurality of bolometer elements 2 arranged in a plane.

For example, the substrate 3 may include a readout integrated circuit for reading out a change in electric resistance value from each of the bolometer elements 2.

The bolometer array 1 may include a sealing member that seals a region where the plurality of bolometer elements 2 are installed to allow an area around the plurality of bolometer elements 2 to be vacuumed.

The plurality of bolometer elements 2 according to the present example embodiment are arranged in first direction and second direction. For example, the plurality of bolometer elements 2 are arranged at equal intervals in the first direction and the second direction.

The first direction and the second direction are in-plane directions in which the plurality of bolometer elements 2 are arranged. The first direction and the second direction are orthogonal to each other.

The plurality of bolometer elements 2 are not particularly limited in posture of installation. However, for convenience of description, a direction orthogonal to the first direction and the second direction is referred to as an overlapping direction (for example, in a vertical direction).

The bolometer array 1 includes, as the plurality of bolometer elements 2, a plurality of first bolometer elements 4 and a plurality of second bolometer elements 5.

The first bolometer elements 4 and the second bolometer elements 5 each detect a band of certain wavelengths that detection target light L includes. For example, the first bolometer elements 4 are each set with, as detection bands, a band of wavelengths ranging from 3 μm to 5 μm and a band of wavelengths ranging from 8 μm to 14 μm, which the detection target light L includes. The detection bands of each of the first bolometer elements 4 are an example of a “first wavelength band”. For example, the second bolometer elements 5 are each set with, as a detection band, a band of wavelengths ranging from 8 μm to 14 μm, which the detection target light L includes. The detection band of each of the second bolometer elements 5 is an example of a “second wavelength band”. The “second wavelength band” according to the present disclosure is included in the “first wavelength band”. For example, the first detection band according to the present example embodiment is a band in which a middle wavelength infrared (MWIR) band and a long wavelength infrared (LWIR) band are combined with each other. The second detection band is a long wavelength infrared (LWIR) band.

When the bolometer array 1 is used in an outdoor environment, the second bolometer elements 5 may be each set with, as a detection band, a band of wavelengths ranging from 8 μm to 11 μm, which the detection target light L includes. In other words, the second detection band may be a part of the LWIR band.

The bolometer elements 2 each roughly divide components in the band of wavelengths that the detection target light L includes into a component falling within the first wavelength band and a component falling within the second wavelength band, and each allow absorption films (a first absorption film 17 and a second absorption film 18 to be described later) included in each of the bolometer elements 2 to absorb the roughly divided components. When a change in temperature in each of the absorption films described above is transmitted to a sensor unit 12 to be described later, the bolometer elements 2 each output the change in temperature in the sensor unit 12 as an electric signal.

A lower limit of an element size of each of the bolometer elements 2 is specified by a limit size for microfabrication processing. For example, when the bolometer elements 2 are each formed through printing, the lower limit described above is specified by a limit size in terms of a print output.

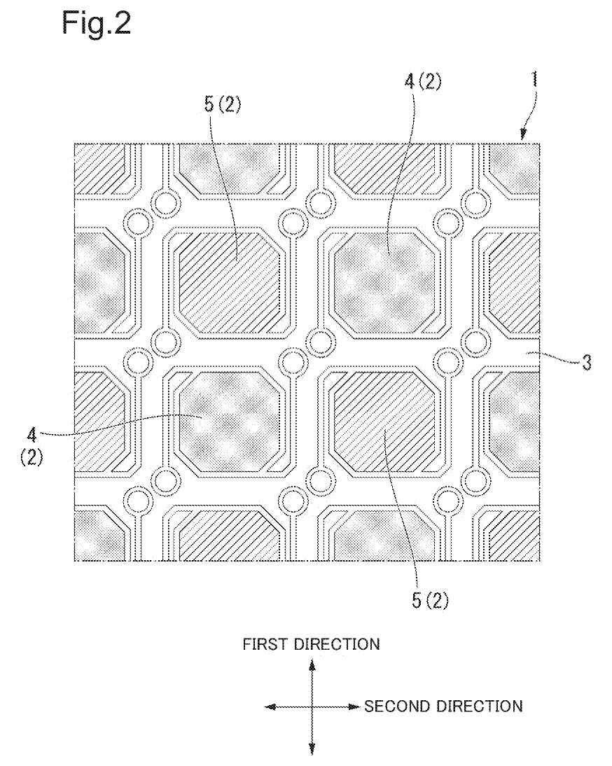

In the plurality of bolometer elements 2 according to the present example embodiment, as illustrated in FIG. 2, the first bolometer elements 4 and the second bolometer elements 5 are alternately arrayed in the first direction, and the first bolometer elements 4 and the second bolometer elements 5 are alternately arrayed in the second direction. When any one of the plurality of first bolometer elements 4 is referred to as a “third bolometer” and any one of the plurality of second bolometer elements 5 is referred to as a “fourth bolometer”, the first bolometer elements 4 are arranged in the first direction with respect to the second bolometer elements 5, and the “third bolometer” is arranged in the second direction with respect to the second bolometer elements 5. The “fourth bolometer” is arranged in the second direction with respect to the first bolometer elements 4 arranged with the second bolometer elements 5 in the first direction.

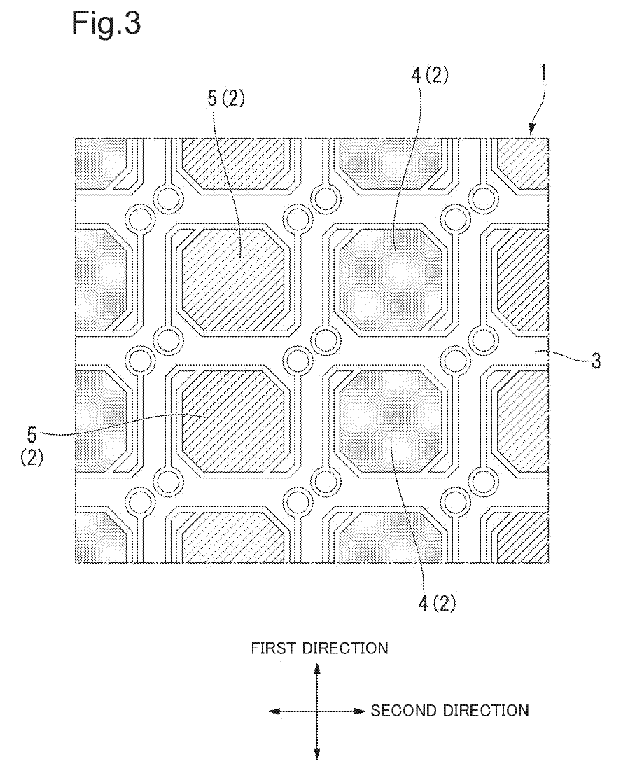

In the plurality of bolometer elements 2, for example, as illustrated in FIG. 3, the first bolometer elements 4 and the second bolometer elements 5 may be alternately arrayed in the first direction, the first bolometer elements 4 may be continuously arrayed in the second direction, and the second bolometer elements 5 may be continuously arrayed in the second direction. When any one of the plurality of first bolometer elements 4 is referred to as a “third bolometer” and any one of the plurality of second bolometer elements 5 is referred to as a “fourth bolometer”, the first bolometer elements 4 are arranged in the first direction with respect to the second bolometer elements 5, and the “third bolometer” is arranged in the second direction with respect to the first bolometer elements 4. The “fourth bolometer” is arranged in the second direction with respect to the second bolometer elements 5 arranged with the first bolometer elements 4 in the first direction.

### First Bolometer

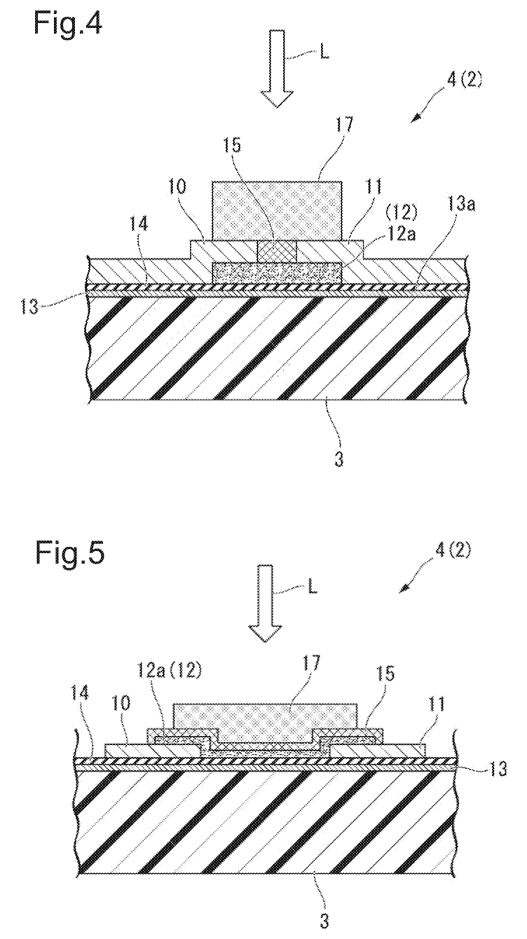

As illustrated in FIG. 4, the first bolometer elements 4 are disposed on the substrate 3. The first bolometer elements 4 each include a first electrode 10, a second electrode 11, a sensor unit 12, an insulating film 14, a passivation film 15, and the first absorption film 17. In FIG. 4, the first electrode 10 and the second electrode 11 are disposed in such a way as to cover an upper portion of the sensor unit 12 in the overlapping direction. Instead of the example described above, as illustrated in FIG. 5, an upper portion of at least one of the first electrode 10 and the second electrode 11 may be covered with the sensor unit 12 in the overlapping direction. As illustrated in FIGS. 4 and 5, the first bolometer elements 4 may each further include a first reflective film 13 as necessary.

### Configuration of First Electrode

The first electrode 10 is an electrode for allowing an electric current to flow to the second electrode 11 via the sensor unit 12.

The first electrode 10 includes a conductive material such as aluminum, copper, gold, or TiAlV.

### Configuration of Second Electrode

The second electrode 11 is an electrode for allowing an electric current to flow to the first electrode 10 via the sensor unit 12.

The second electrode 11 includes a conductive material such as aluminum, copper, gold, or TiAlV.

For example, in a direction in which the first electrode 10 and the second electrode 11 face each other, a length between the first electrode 10 and the second electrode 11 may be equal to or longer than 500 nm and equal to or shorter than 3 μm.

### Configuration of Sensor Unit

The sensor unit 12 detects a change in temperature in each of the absorption films (the first absorption film 17 and the second absorption film 18) that have received infrared rays, and detects an amount related to intensity of the infrared rays that each of the absorption films has received as an amount of change in electric resistance value.

The bolometer elements 2 each include a material having a large absolute value of a temperature coefficient related to resistance as the sensor unit 12. Although, as the sensor unit 12, a carbon nanotube network film, a vanadium oxide film, or an amorphous silicon film is used, for example, it is preferable that the bolometer elements 2 each include a carbon nanotube film 12a.

As a change in temperature in each of the absorption films (the first absorption film 17 and the second absorption film 18) that have received infrared rays is transmitted to the carbon nanotube film 12a, the carbon nanotube film 12a changes in temperature.

The carbon nanotube film 12a is an electric resistance body that changes a value of an electric resistance between the first electrode 10 and the second electrode 11 in accordance with a change in temperature in the carbon nanotube film 12a.

### Configuration of Carbon Nanotube Film

The carbon nanotube film 12a is electrically coupled to the first electrode 10 and the second electrode 11.

For example, a thickness of the carbon nanotube film 12a may be preferably equal to or thicker than 0.7 nm and equal to or thinner than 50 nm, more preferably equal to or thicker than 0.7 nm and equal to or thinner than 10 nm, and further preferably equal to or thicker than 0.7 nm and equal to or thinner than 5 nm.

For example, it is preferable that the carbon nanotube film 12a includes, as a main component, semiconducting single-walled carbon nanotubes.

For example, the carbon nanotube film 12a may include preferably semiconducting carbon nanotubes at a percentage equal to or higher than 90%, further preferably semiconducting carbon nanotubes at a percentage equal to or higher than 95%, and more preferably semiconducting carbon nanotubes at a percentage equal to or higher than 98%. At a percentage equal to or higher than 98%, a further improvement in characteristics is expected. On the other hand, within a range between a percentage equal to or higher than 95% and a percentage lower than 98%, an improvement in characteristics is expected while a process cost is reduced.

For example, the carbon nanotube film 12a may include semiconducting carbon nanotubes extracted with an electric-field-induced layer formation method (ELF method). Although semiconducting carbon nanotubes extracted with another method may be included, it is preferable that the carbon nanotube film 12a includes semiconducting carbon nanotubes extracted with the ELF method. From a viewpoint of hardly adversely affecting an electrical characteristic of each of the bolometer elements 2, a nonionic surfactant may be used in the ELF method for extracting semiconducting carbon nanotubes.

For example, a length of one semiconducting carbon nanotube separated with the ELF method may range from 10 nm to 1 μm inclusive.

For example, in the carbon nanotube film 12a, the semiconducting carbon nanotubes may be bundled. At that time, a length of those in a bundle state may range from approximately 100 nm to 10 μm inclusive.

For example, the carbon nanotube film 12a may be a carbon nanotube network film in which a plurality of carbon nanotubes are randomly oriented to mutually form a network.

In the present disclosure, the “carbon nanotube network film” refers to a carbon nanotube film in which a plurality of carbon nanotubes are randomly oriented to mutually form a network.

### Configuration of First Reflective Film

The first reflective film 13 is a thin film disposed between the insulating film 14 and the carbon nanotube film 12a. From another viewpoint, the first reflective film 13 is positioned on an opposite side to the first absorption film 17 with respect to the carbon nanotube film 12a.

The first reflective film 13 reflects the detection-target light L that the first absorption film 17 has failed to absorb and has passed through the sensor unit 12 from a lower position toward an upper position.

Specifically, the first reflective film 13 reflects the detection-target light L that has entered an upper surface 13a.

It is sufficient that the first reflective film 13 includes a material capable of reflecting the detection-target light L.

The first reflective film 13 is disposed parallel to a plane including the first direction and the second direction. A main component of the first reflective film 13 disposed at such a position may be a metal or an alloy. When the first bolometer elements 4 are each regarded as a thin film transistor, a function as a gate electrode is imparted to the sensor unit 12.

### Configuration of Insulating Film

In the overlapping direction, the insulating film 14 is formed to cover the first reflective film 13 and/or the substrate 3 from above. The insulating film 14 prevents a short circuit from occurring between the first electrode 10 and the first reflective film 13 or the substrate 3. The insulating film 14 prevents a short circuit from occurring between the second electrode 11 and the first reflective film 13 or the substrate 3.

### Configuration of Passivation Film

The passivation film 15 covers the carbon nanotube film 12a. The passivation film 15 may cover the carbon nanotube film 12a and cover the first electrode 10 and/or the second electrode 11.

The passivation film 15 is a thin film formed to include an insulating body of, for example, a metal oxide such as silicon oxide, hafnium oxide, or aluminum oxide, silicon nitride, or a resin.

### Configuration of First Absorption Film

The first absorption film 17 plays a role of selectively absorbing infrared rays falling within the “first wavelength band” for the detection-target light L. The absorbed infrared rays are converted into heat, allowing a change in temperature in the first absorption film 17 to occur. A change in temperature in the first absorption film 17 is transmitted to the sensor unit 12, and a change in electric resistance value is sensed in the carbon nanotube film 12a in each of the first bolometer elements 4.

For example, the first absorption film 17 is formed above the insulating film 14. At that time, in each of the first bolometer elements 4, the first absorption film 17 overlaps the carbon nanotube film 12a in the vertical direction.

The first reflective film 13 described above reflects the detection-target light L that the first absorption film 17 has failed to absorb and has passed through the sensor unit 12 toward the sensor unit 12, and reflects the detection-target light L toward the first absorption film 17. Since the first bolometer elements 4 each include the first reflective film 13, an amount of absorption of infrared rays by the first absorption film 17 is improved, allowing the absorbed infrared rays to be efficiently converted into heat.

The first absorption film includes a carbon material or a gray body material. For example, the carbon material is a sintered body of a carbon material including graphite. For example, the gray body material is a sintered body of silicon carbide.

The first absorption film 17 may be a composite with a resin.

### Second Bolometer

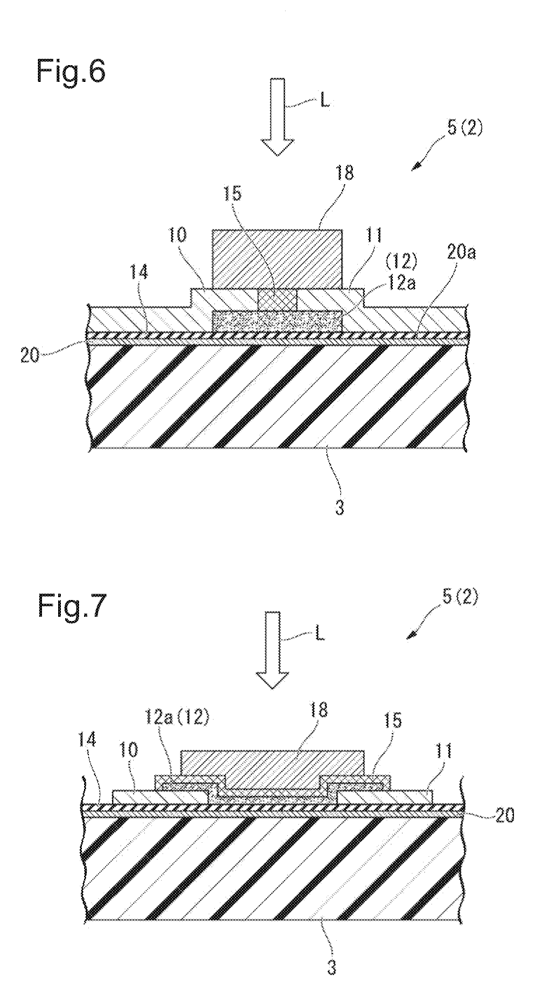

As illustrated in FIG. 6, similar to the first bolometer elements 4, the second bolometer elements 5 each include the first electrode 10, the second electrode 11, the sensor unit 12, the insulating film 14, the passivation film 15, and the second absorption film 18. In FIG. 6, the first electrode 10 and the second electrode 11 are disposed in such a way as to cover the upper portion of the sensor unit 12 in the overlapping direction. Instead of the example described above, as illustrated in FIG. 7, the upper portion of at least one of the first electrode 10 and the second electrode 11 may be covered with the sensor unit 12 in the overlapping direction. As illustrated in FIGS. 6 and 7, the second bolometer elements 5 may each further include a second reflective film 20 as necessary.

In each of the second bolometer elements 5, the insulating film 14 prevents a short circuit from occurring between the first electrode 10 and the second reflective film 20 or the substrate 3. The insulating film 14 prevents a short circuit from occurring between the second electrode 11 and the second reflective film 20 or the substrate 3.

### Configuration of Second Reflective Film

The second reflective film 20 is a thin film disposed between the insulating film 14 and the carbon nanotube film 12a. From another viewpoint, the second reflective film 20 is positioned on an opposite side to the second absorption film 18 with respect to the carbon nanotube film 12a.

The second reflective film 20 reflects the detection-target light L that the second absorption film 18 has failed to absorb and has passed through the sensor unit 12 from a lower position toward an upper position.

Specifically, the second reflective film 20 reflects the detection-target light L that has entered an upper surface 20a.

It is sufficient that the second reflective film 20 includes a material capable of reflecting the detection-target light L.

The second reflective film 20 is disposed parallel to a plane including the first direction and the second direction. A main component of the second reflective film 20 disposed at such a position may be a metal or an alloy. When the second bolometer elements 5 are each regarded as a thin film transistor, the function as the gate electrode is imparted to the sensor unit 12.

### Configuration of Second Absorption Film

The second absorption film 18 plays a role of selectively absorbing infrared rays falling within the “second wavelength band” for the detection-target light L. As described above, the “second wavelength band” is included in the “first wavelength band”. Therefore, the second absorption film 18 selectively absorbs components including those falling within the “second wavelength band” among components including those falling within the “first wavelength band”. The absorbed components are converted into heat, allowing a change in temperature in the second absorption film 18 to occur. A change in temperature in the second absorption film 18 is transmitted to the sensor unit 12, and a change in electric resistance value is sensed in the carbon nanotube film 12a in each of the second bolometer elements 5.

For example, the second absorption film 18 is formed above the insulating film 14 illustrated in FIG. 6. At that time, in each of the second bolometer elements 5, the second absorption film 18 overlaps the carbon nanotube film 12a in the vertical direction.

The second reflective film 20 described above reflects the detection-target light L that the second absorption film 18 has failed to absorb and has passed through the sensor unit 12 toward the sensor unit 12, and reflects the detection-target light L toward the second absorption film 18. Since the second bolometer elements 5 each include the second reflective film 20, an amount of absorption of infrared rays by the second absorption film 18 is improved, allowing the absorbed infrared rays to be efficiently converted into heat.

The second absorption film 18 is a portion including a metal oxide. For example, the portion is a sintered body of Yb₃Ga₅O₁₂, Y₃Ga₅O₁₂, Er₃Ga₅O₁₂, Al₂O₃, Y₂O₃, or Y₃Al₅O₁₂.

The second absorption film 18 may be a composite with a resin.

### Operation of Bolometer Array

Operation of the bolometer array 1 according to the present example embodiment will be described.

In each of the first bolometer elements 4 and the second bolometer elements 5, when the detection-target light L enters the bolometer array 1, some components falling within the band of wavelengths that the detection target light L includes are selectively absorbed by the first absorption films 17 and the second absorption films 18, and the absorbed components heat each of the absorption films (the first absorption films 17 and the second absorption films 18). As each of the absorption films changes in temperature due to the heating, the change in temperature in each of the absorption films is transmitted to each of the sensor units 12, allowing the carbon nanotube films 12a to each change in electric resistance value. With these configurations, a value of an electric resistance between each of the first electrodes 10 and each of the second electrodes 11 changes in accordance with the change in temperature in each of the carbon nanotube films 12a.

The first bolometer elements 4 and the second bolometer elements 5 each electrically detect a change in electric resistance value in each of the carbon nanotube films 12a by allowing an electric current to flow between the first electrode 10 and the second electrode 11, and output a result of the detection.

In the first bolometer elements 4 and the second bolometer elements 5, the bands (detection bands) of wavelengths to be absorbed partially overlap each other. The detection band of each of the second bolometer elements 5 is included in the detection band of each of the first bolometer elements 4. Therefore, different pieces of information are included between an image based on a result of detection, which is to be outputted from each of the first bolometer elements 4, and an image based on a result of detection, which is to be outputted from each of the second bolometer elements 5. For example, acquiring such a difference between such images makes it possible to generate a new image in which brightness and darkness are easily distinguishable, compared with each of the images before the difference is acquired.

### Operation and Effect

The bolometer array 1 according to the present example embodiment includes: the first bolometer elements 4 each including the first absorption film 17 and capable of absorbing infrared rays falling within the first wavelength band; and the second bolometer elements 5 each including the second absorption film 18 and capable of absorbing infrared rays falling within the second wavelength band included in the first wavelength band described above.

According to such a configuration, the first absorption films 17 and the second absorption films 18 are each capable of selecting a wavelength of an infrared ray, which is to be absorbed by each of the bolometers (the first bolometer elements 4 and the second bolometer elements 5). Therefore, the bolometer elements are each less likely to be complicated in structure, compared with a case where a filter that limits wavelengths of infrared rays to be absorbed is provided in each bolometer element. As to the bolometer array 1 according to the present example embodiment, as described above, it is easy to manufacture the bolometer array.

According to the configuration described above, acquiring a difference between images that are an image based on a result of detection, which is to be outputted from each of the first bolometer elements 4 in each of which infrared rays falling within the first wavelength band are selected by the first absorption films 17, and an image based on a result of detection, which is to be outputted from each of the second bolometer elements 5 in each of which infrared rays falling within the second wavelength band are selected by the second absorption films 18, makes it possible to provide a difference in brightness for pixels to be acquired from each of the bolometer elements 2. When the first detection band is a combination of the MWIR band and the LWIR band and the second detection band is the LWIR band, for example, an object at a high temperature may be enhanced in contrast in such a new image as described above.

A comparative example of the bolometer array 1 according to the present example embodiment will be described.

As the comparative example, there is a quantum type infrared detector that requires cooling, such as Type II Super-Lattice (T2SL). Compared with acquiring an image provided with a difference in brightness with a T2SL from two detection bands in which one of the two detection bands is included in another one of the two detection bands, allowing the bolometer array 1 according to the present example embodiment to be capable of acquiring such an image as described above may contribute to a reduction in cost and/or a reduction in size. Allowing the second absorption films 18 having selectivity for a wavelength to be absorbed to be used for each of the second bolometer elements 5 facilitates acquisition of such an image as described above.

From another viewpoint, using a carbon nanotube network as each of the sensor units 12 makes it possible to manufacture bolometers with improved sensitivity.

In the bolometer array 1 according to the present example embodiment, the second bolometer elements 5 each further include a reflective film (for example, the second reflective film 20) that reflects the detection-target light L. The reflective film described above is positioned on the opposite side to the second absorption film 18 with respect to the film described above.

According to such a configuration, reflected light of the detection-target light L, which the second absorption films 18 have failed to absorb and has passed through the film described above, may be absorbed by the film described above in each of the second bolometer elements 5. As a result, in the second bolometer elements 5, an amount of absorption of infrared rays falling within the LWIR band is improved. When a difference between an image based on a result of detection, which is outputted from each of the second bolometer elements 5, and an image based on a result of detection, which is outputted from each of the first bolometer elements 4, is acquired, the difference is expected to increase.

Therefore, such a new image as described above may be further enhanced in contrast.

In the bolometer array 1 according to the present example embodiment, each of the first absorption films 17 or each of the second absorption films 18 is a composite with a resin.

According to such a configuration, compatibility between the first absorption films 17 or the second absorption films 18 and a printed device is improved, making it possible to form the first absorption films 17 or the second absorption films 18 through printing.

In the bolometer array 1 according to the present example embodiment, the first absorption films 17 include a carbon material or a gray body material.

According to such a configuration, the first detection band is a band in which the MWIR band and the LWIR band are combined with each other, which is preferable when the bolometer array 1 is used in an outdoor environment.

In the bolometer array 1 according to the present example embodiment, the carbon material described above is a sintered body of a carbon material including graphite, and the gray body material described above is a sintered body of silicon carbide.

According to such a configuration, the bolometer array 1 becomes more preferable when used in an outdoor environment.

To further provide selectivity in wavelength that the first absorption films 17 absorb, a particle size of powder serving as a material of a sintered body may be appropriately set, and a volume ratio of gaps with respect to a total volume of the sintered body (hereinafter also referred to as “porosity”) may be appropriately adjusted.

In the bolometer array 1 according to the present example embodiment, the second absorption films 18 are portions including a metal oxide.

According to such a configuration, the second detection band is the LWIR band, which is preferable when the bolometer array 1 is used in an outdoor environment.

In the bolometer array 1 according to the present example embodiment, the portions described above are sintered bodies of Yb₃Ga₅O₁₂, Y₃Ga₅O₁₂, Er₃Ga₅O₁₂, Al₂O₃, Y₂O₃, or Y₃Al₅O₁₂.

According to such a configuration, the bolometer array 1 becomes more preferable when used in an outdoor environment.

To further provide selectivity in wavelength that the second absorption films 18 absorb, a particle size of powder serving as a material of a sintered body may be appropriately set, and a porosity of the sintered body may be appropriately adjusted.

The bolometer array 1 according to the present example embodiment further includes third bolometers each including the first absorption film 17 and fourth bolometers each including the second absorption film 18. The first bolometer elements 4 are arranged in the first direction with respect to the second bolometer elements 5. The third bolometers described above are arranged in the second direction intersecting the first direction described above with respect to the second bolometer elements 5. The fourth bolometers described above are arranged in the second direction described above with respect to the first bolometer elements 4.

According to such a configuration, two bolometers capable of absorbing infrared rays falling within the first wavelength band described above through the first absorption films 17 and two bolometers capable of absorbing infrared rays falling within the second wavelength band described above through the second absorption films 18 are arranged adjacent to each other in both the first direction and the second direction. Therefore, parallax between an image acquired from infrared rays falling within the first wavelength band described above and an image acquired from the second wavelength band described above is reduced. Deviation between an image acquired from infrared rays falling within the first wavelength band described above and an image acquired from the second wavelength band described above is reduced.

The bolometer array 1 according to the present example embodiment further includes third bolometers each including the first absorption film 17 and fourth bolometers each including the second absorption film 18. The first bolometer elements 4 are arranged in the first direction with respect to the second bolometer elements 5. The third bolometers described above are arranged in the second direction intersecting the first direction described above with respect to the first bolometer elements 4. The fourth bolometers described above are arranged in the second direction described above with respect to the second bolometer elements 5.

According to such a configuration, two bolometers capable of absorbing infrared rays falling within the first wavelength band described above through the first absorption films 17 and two bolometers capable of absorbing infrared rays falling within the second wavelength band described above through the second absorption films 18 are arranged adjacent to each other in the first direction described above. The absorption films (the first absorption films 17 and the second absorption films 18) are each arranged in a line in the second direction described above. Therefore, when outputs of the bolometer elements 2 are to be sequentially processed, the outputs of some of the bolometer elements 2 that have detected infrared rays falling within an identical wavelength band are continuously processed. Therefore, there is a possibility that it is possible to reduce a load of processing a result of detection by the bolometer array 1.

### Second Example Embodiment

Hereinafter, one example embodiment according to the present disclosure will be described with reference to the drawings.

### Configuration

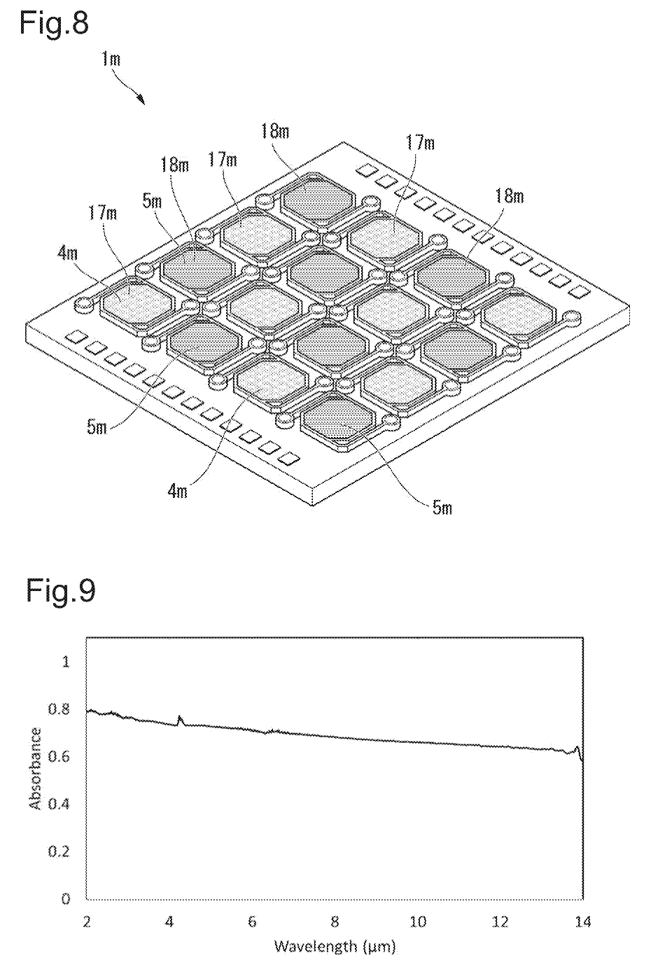

As illustrated in FIG. 8, a bolometer array 1m includes: first bolometer elements 4m each including a first absorption film 17m and capable of absorbing infrared rays falling within a first wavelength band; and second bolometer elements 5m each including a second absorption film 18m and capable of absorbing infrared rays falling within a second wavelength band included in the first wavelength band described above.

### Operation and Effect

According to the present example embodiment, the first absorption films 17m and the second absorption films 18m are each capable of selecting a wavelength of an infrared ray, which is to be absorbed by each of the bolometers (the first bolometer elements 4m and the second bolometer elements 5m). It is possible to detect infrared rays falling within a plurality of wavelength bands. The bolometer elements are each less likely to be complicated in structure, compared with a case where a filter that limits wavelengths of infrared rays to be absorbed is provided in each bolometer. As to the bolometer array 1m according to the present example embodiment, as described above, it is easy to manufacture the bolometer array.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

### Examples

Hereinafter, effects of the present disclosure will be described more specifically by way of examples. Conditions in the examples are exemplary conditions adopted to confirm feasibility and effects of the present disclosure, and the present disclosure is not limited to the exemplary conditions. The present disclosure may adopt various conditions as long as the object of the present disclosure is achieved without departing from the gist of the present disclosure.

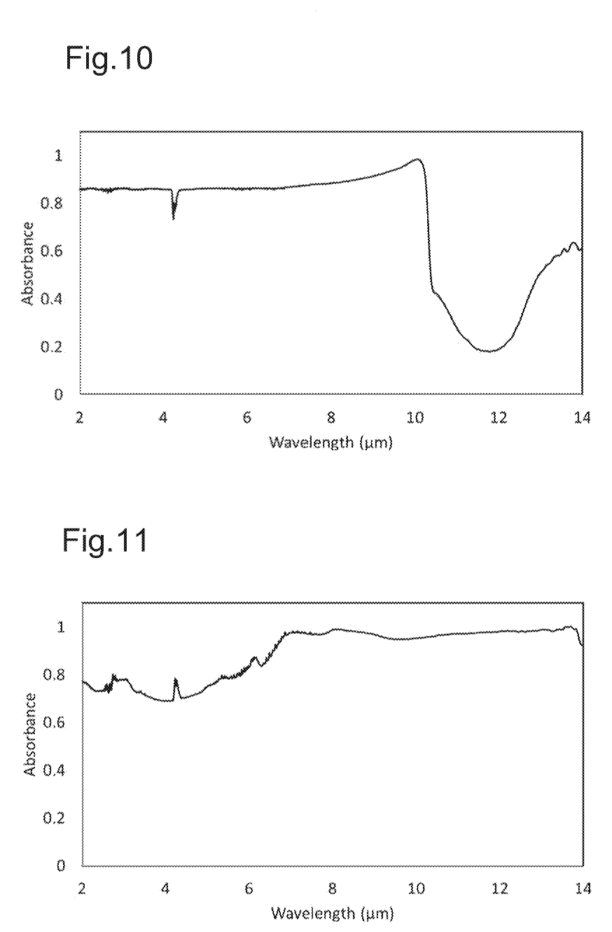

FIGS. 9 to 15 each illustrate an absorption spectrum of each sintered body, which was measured with FT-IR using an integrating sphere in a room temperature environment. FIG. 9 illustrates the absorption spectrum of a sintered body (graphite) of a carbon material that selectively absorbs infrared rays falling within the first wavelength band. FIGS. 10 to 11 each illustrate the absorption spectrum of a sintered body of silicon carbide that selectively absorbs infrared rays falling within the first wavelength band.

From FIG. 9, it has been confirmed that the sintered body (graphite) of the carbon material absorbed infrared rays falling within the first wavelength band in which the MWIR band and the LWIR band were combined. An absorbance for the graphite in the MWIR band and the LWIR band ranged from 0.6 to 0.8 inclusive.

From FIGS. 10 to 11, it has been confirmed that the sintered bodies of silicon carbide absorbed infrared rays falling within the first wavelength band in which the MWIR band and the LWIR band were combined. It is illustrated in here that the absorbance for each of the sintered bodies of silicon carbide in the MWIR band and the LWIR band changed due to application of a black-body coating material.

FIG. 10 is the absorption spectrum of the sintered body of silicon carbide before the black-body coating material was applied. With the silicon carbide before the black-body coating material was applied, the absorbance for the sintered body of silicon carbide in the MWIR band ranged from 0.8 to 0.9 inclusive. With the sintered body of silicon carbide before the black-body material was applied, on the other hand, it has been confirmed that the absorbance for the sintered body of silicon carbide in the LWIR band sharply dropped for wavelengths longer than 10 μm.

FIG. 11 is the absorption spectrum of the sintered body of silicon carbide after the black-body coating material was applied. The black-body coating material was JSC-3 manufactured by Japansensor Corporation, and main components were SiZrO₄, Cr₂O₃, and an iron oxide-based inorganic pigment. With the sintered body of silicon carbide after the black-body coating material was applied, the absorbance for the sintered body of silicon carbide in the MWIR band ranged from 0.7 to 0.8 inclusive. The absorbance for the sintered body of silicon carbide in the LWIR band ranged from 0.9 to 1.0 inclusive. It has been confirmed that, after the black-body coating material was applied to the sintered body of silicon carbide, there has been an increase in absorbance in the LWIR band.

According to FIG. 10, it has been estimated that, since a peak wavelength of thermal radiation around a room temperature is approximately 10 μm, it is possible to acquire an image, with the second bolometer elements 5 that may have information different from that of the first bolometer elements 4, even when a band of wavelengths ranging from 8 μm to 11 μm inclusive, which the detection target light L includes, is set as a detection band.

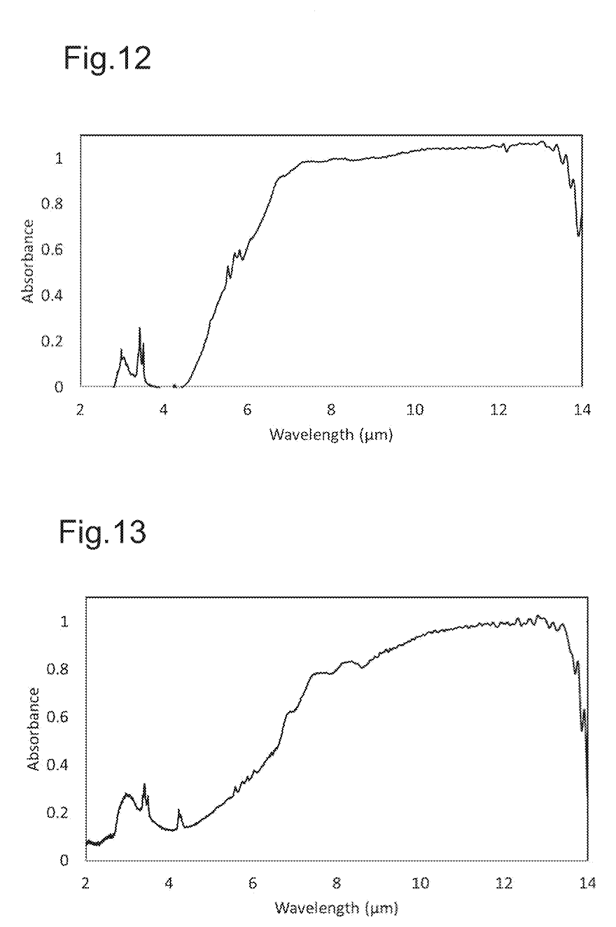

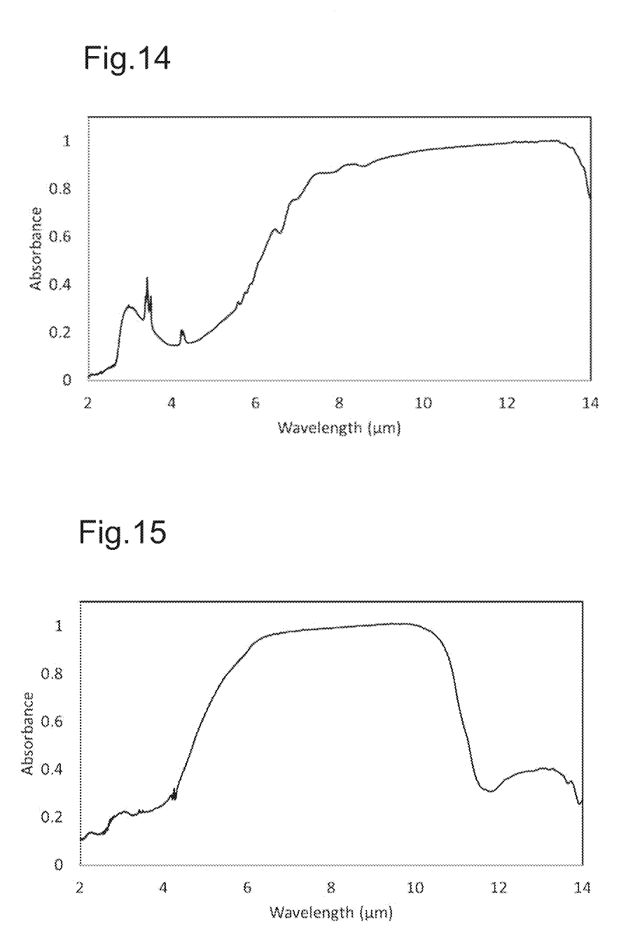

FIG. 12 illustrates an absorption spectrum of a sintered body of Yb₃Ga₅O₁₂ that selectively absorbs infrared rays falling within the second wavelength band. FIG. 13 illustrates an absorption spectrum of a sintered body of Y₃Ga₅O₁₂ that selectively absorbs infrared rays falling within the second wavelength band. FIG. 14 illustrates an absorption spectrum of a sintered body of Er₃Ga₅O₁₂ that selectively absorbs infrared rays falling within the second wavelength band. FIG. 15 illustrates an absorption spectrum of a sintered body of Al₂O₃ that selectively absorbs infrared rays falling within the second wavelength band.

From FIG. 12, it has been confirmed that the sintered body of Yb₃Ga₅O₁₂ absorbed infrared rays falling within the second wavelength band that is the LWIR band. An absorbance for the sintered body of Yb₃Ga₅O₁₂ in the LWIR band was mostly close to 1.0. Since an absorbance for the sintered body of Yb₃Ga₅O₁₂ in the MWIR band was mostly close to 0, on the other hand, it has been confirmed that the sintered body of Yb₃Ga₅O₁₂ selectively absorbed infrared rays falling within the second wavelength band.

From FIG. 13, it has been confirmed that the sintered body of Y₃Ga₅O₁₂ absorbed infrared rays falling within the second wavelength band that is the LWIR band. An absorbance for the sintered body of Y₃Ga₅O₁₂ in the LWIR band was mostly equal to or greater than 0.8. Since an absorbance for the sintered body of Y₃Ga₅O₁₂ in the MWIR band was mostly close to 0.2, on the other hand, it has been confirmed that the sintered body of Y₃Ga₅O₁₂ selectively absorbed infrared rays falling within the second wavelength band.

From FIG. 14, it has been confirmed that the sintered body of Er₃Ga₅O₁₂ absorbed infrared rays falling within the second wavelength band that is the LWIR band. An absorbance for the sintered body of Er₃Ga₅O₁₂ in the LWIR band was mostly equal to or greater than 0.8. Since an absorbance for the sintered body of Er₃Ga₅O₁₂ in the MWIR band was mostly close to 0.2, on the other hand, it has been confirmed that the sintered body of Er₃Ga₅O₁₂ selectively absorbed infrared rays falling within the second wavelength band.

In FIG. 15, an absorbance for the sintered body of Al₂O₃ in the MWIR band ranged from 0.2 to 0.5 inclusive. It has been confirmed on the other hand that the absorbance for the sintered body of Al₂O₃ in the LWIR band sharply dropped for wavelengths longer than 10 μm. Since the absorbance for the sintered body of Al₂O₃ for wavelengths ranging from 8 μm to 10 μm inclusive was approximately 1.0, however, it has been confirmed that the sintered body of Al₂O₃ selectively absorbed infrared rays falling within the second wavelength band when the LWIR band was partially narrowed.

According to FIG. 15, it has been estimated that, since the peak wavelength of thermal radiation around the room temperature was approximately 10 μm, it is possible to acquire an image with the second bolometer elements 5, even when a band of wavelengths ranging from 8 μm to 11 μm inclusive, which the detection target light L includes, is set as a detection band.

As to the absorption spectra of the sintered bodies of Y₂O₃ and Y₃Al₅O₁₂, it has also been observed identical tendencies to those illustrated in FIGS. 12 to 15.

As described above, it is possible to determine that it is possible to generate a new image with the bolometer array 1 according to the present disclosure, in which the first bolometer elements 4 each include a sintered body of a carbon material including graphite or a sintered body of silicon carbide, and the second bolometer elements 5 each include a sintered body of Yb₃Ga₅O₁₂, Y₃Ga₅O₁₂, Er₃Ga₅O₁₂, Al₂O₃, Y₂O₃, or Y₃Al₅O₁₂.

Some or all of the above-described example embodiments may be described as the following supplementary notes, but are not limited to the following supplementary notes.

### Supplementary Note 1

A bolometer array including:

a first bolometer element including a first absorption film and capable of absorbing infrared rays falling within a first wavelength band; and

a second bolometer element including a second absorption film and capable of absorbing infrared rays falling within a second wavelength band included in the first wavelength band.

### Supplementary Note 2

The bolometer array described in Supplementary Note 1, in which

the first bolometer element and the second bolometer element each include:

a first electrode;

a second electrode; and

a film electrically coupled to the first electrode and the second electrode and including carbon nanotubes, and

the first absorption film overlaps the film in the first bolometer element, and

the second absorption film overlaps the film in the second bolometer element.

### Supplementary Note 3

The bolometer array described in Supplementary Note 2, in which

the second bolometer element further includes a reflective film that reflects detection-target light, and

the reflective film is positioned on an opposite side to the second absorption film with respect to the film.

### Supplementary Note 4

The bolometer array described in any one of Supplementary Notes 1 to 3, in which

the first absorption film or the second absorption film is a composite with a resin.

### Supplementary Note 5

The bolometer array described in any one of Supplementary Notes 1 to 4, in which

the first absorption film includes a carbon material or a gray body material.

### (Supplementary Note 6

The bolometer array described in Supplementary Note 5, in which

the carbon material is a sintered body of a carbon material including graphite, and

the gray body material is a sintered body of silicon carbide.

### Supplementary Note 7

The bolometer array described in Supplementary Note 5 or 6, in which

the second absorption film is a portion including a metal oxide.

### Supplementary Note 8

The bolometer array described in Supplementary Note 7, in which

the portion is a sintered body of Yb₃Ga₅O₁₂, Y₃Ga₅O₁₂, Er₃Ga₅O₁₂, Al₂O₃, Y₂O₃, or Y₃Al₅O₁₂.

### (Supplementary Note 9

The bolometer array described in any one of Supplementary Notes 1 to 8,

further including:

a third bolometer element including the first absorption film; and

a fourth bolometer element including the second absorption film;

in which

the first bolometer element is arranged in first direction with respect to the second bolometer element,

the third bolometer element is arranged in second direction intersecting the first direction with respect to the second bolometer element, and

the fourth bolometer element is arranged in the second direction with respect to the first bolometer element.

### Supplementary Note 10

The bolometer array described in any one of Supplementary Notes 1 to 8,

further including:

a third bolometer element including the first absorption film; and

a fourth bolometer element including the second absorption film;

in which

the first bolometer element is arranged in first direction with respect to the second bolometer element,

the third bolometer element is arranged in second direction intersecting the first direction with respect to the first bolometer element, and

the fourth bolometer element is arranged in the second direction with respect to the second bolometer element.

1. A bolometer array comprising:
a first bolometer element including a first absorption film and capable of absorbing infrared rays falling within a first wavelength band; and
a second bolometer element including a second absorption film and capable of absorbing infrared rays falling within a second wavelength band included in the first wavelength band.

2. The bolometer array according to claim 1, wherein
the first bolometer element and the second bolometer element each include:
a first electrode;
a second electrode; and
a film electrically coupled to the first electrode and the second electrode and including carbon nanotubes, and
the first absorption film overlaps the film in the first bolometer element, and
the second absorption film overlaps the film in the second bolometer element.

3. The bolometer array according to claim 2, wherein
the second bolometer element further includes a reflective film that reflects detection-target light, and
the reflective film is positioned on an opposite side to the second absorption film with respect to the film.

4. The bolometer array according to claim 1, wherein
the first absorption film or the second absorption film is a composite with a resin.

5. The bolometer array according to claim 1, wherein
the first absorption film includes a carbon material or a gray body material.

6. The bolometer array according to claim 5, wherein
the carbon material is a sintered body of a carbon material including graphite, and
the gray body material is a sintered body of silicon carbide.

7. The bolometer array according to claim 5, wherein
the second absorption film is a portion including a metal oxide.

8. The bolometer array according to claim 7, wherein
the portion is a sintered body of Yb₃Ga₅O₁₂ Y₃Ga₅O₁₂ Er₃Ga₅O₁₂ Al₂O₃ Y₂O₃ or Y₃Al₅O₁₂.

9. The bolometer array according to claim 1,
further comprising:
a third bolometer element including the first absorption film; and
a fourth bolometer element including the second absorption film;
wherein
the first bolometer element is arranged in first direction with respect to the second bolometer element,
the third bolometer element is arranged in second direction intersecting the first direction with respect to the second bolometer element, and
the fourth bolometer element is arranged in the second direction with respect to the first bolometer element.

10. The bolometer array according to claim 1,
further comprising:
a third bolometer element including the first absorption film; and
a fourth bolometer element including the second absorption film;
wherein
the first bolometer element is arranged in first direction with respect to the second bolometer element,
the third bolometer element is arranged in second direction intersecting the first direction with respect to the first bolometer element, and
the fourth bolometer element is arranged in the second direction with respect to the second bolometer element.
